(19) United States
(12) Patent Application Publication
(10) Pub. No.: US 2026/0300668 A1
(43) Pub. Date: Oct. 1, 2026

(54) REMOTE READING SYSTEM INVENTORY TRACKING

(71) Applicant: QUALCOMM Incorporated, San Diego, CA (US)

(72) Inventors: Qi FU, San Diego, CA (US); Bhupesh Manoharlal UMATT, San Diego, CA (US); Kiran PATIL, San Diego, CA (US); Scott HOOVER, Del Mar, CA (US); Vishal DALMIYA, San Diego, CA (US); Ajay Vignesh JAYAPRAKASH, San Diego, CA (US); Sheng-Yuan TU, San Diego, CA (US); Chetan Jagdeesh BHARADWAJ, Erie, CO (US); Sayak SAHA, San Diego, CA (US)

(21) Appl. No.: 19/090,290

(22) Filed: Mar. 25, 2025

(51) Int. Cl. G06K 19/07; H04B 5/77; H04W 52/38

(52) U.S. Cl. CPC G06K 19/0723; H04B 5/77; H04W 52/38

(57) ABSTRACT

Systems and techniques are described herein for wireless communication. For example, a computing device can determine, based on transmit power of a Short Range Device (SRD), a variable associated with tracking remote tag inventory. The computing device can adjust the variable based on a reply or absence of the reply from one or more remote tags of a plurality of remote tags. The computing device can adjust the variable based on a counter configured to track and indicate the plurality of remote tags are inventoried, wherein the counter is reset based on adjustment of the variable. The computing device can determine, based on an absence of a subsequent reply from the one or more remote tags of the plurality of remote tags, the adjusted variable, and the transmit power of the SRD, to complete remote tag inventory tracking associated with an area in an environment.

### FIELD

The present disclosure generally relates to wireless communication using a remote reading system. For example, aspects of the present disclosure relate to systems and techniques for remote reading tag inventory tracking.

### BACKGROUND

Wireless communication technologies can be classified based on range of technologies. For example, short range wireless communication can enable wireless communication over relatively short distances (e.g., within thirty meters) and long range wireless communication can enable wireless communication over relatively long distances (e.g., more than thirty meters). Remote reading systems, such as Radio Frequency Identification (RFID) systems, are generally classified as short range wireless communication. Remote reading technologies generally provide wireless transfer of data between a short range device (e.g., a reader such as a remote tag reader or an RFID reader device) and a remote tag or transponder (e.g., an RFID tag). Remote reading systems can be used for identification, tracking, data storage, etc. For example, remote reading systems can be used to identify and/or track various items, such as packages in transit, boxes in warehouses, products on shelves of a store, etc.

A remote tag may be attached to an item to be tracked. Remote tags generally include data storage and an antenna. The data storage stores information corresponding to the associated item. In such an example, the information can include identifiers of the item such as a name, a serial number, manufacturer, etc. The antenna can allow information from the remote tag, or the remote tag, to be read by a remote tag reader (or another short range device (SRD)), which transmits an interrogating signal to one or more remote tags within communication range. The remote tag reader can power remote tags. For example, the interrogating signal from the remote tag reader can be used to power the remote tag. Other remote tags, such as active or semi-active remote tags can include a power source (e.g., a battery) to power the remote tag.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for wireless communications is provided. The apparatus includes at least one memory and at least one processor coupled to the at least one memory and configured to: determine, based on transmit power of a Short Range Device (SRD), a variable associated with tracking remote tag inventory; adjust the variable based on a reply or absence of the reply from one or more remote tags of a plurality of remote tags; adjust the variable based on a counter configured to track and indicate the plurality of remote tags are inventoried, wherein the counter is reset based on adjustment of the variable; and determine, based on an absence of a subsequent reply from the one or more remote tags of the plurality of remote tags, the adjusted variable, and the transmit power of the SRD, to complete remote tag inventory tracking associated with an area in an environment.

In some aspects, a method for wireless communications is provided. The method includes: determining, based on transmit power of a Short Range Device (SRD), a variable associated with tracking remote tag inventory; adjusting the variable based on a reply or absence of the reply from one or more remote tags of a plurality of remote tags; adjusting the variable based on a counter configured to track and indicate the plurality of remote tags are inventoried, wherein the counter is reset based on adjustment of the variable; and determining, based on an absence of a subsequent reply from the one or more remote tags of the plurality of remote tags, the adjusted variable, and the transmit power of the SRD, to complete remote tag inventory tracking associated with an area in an environment.

In some aspects, a non-transitory computer-readable medium is provided having stored thereon instructions that, when executed by at least one processor, cause the at least one processor to: determine, based on transmit power of a Short Range Device (SRD), a variable associated with tracking remote tag inventory; adjust the variable based on a reply or absence of the reply from one or more remote tags of a plurality of remote tags; adjust the variable based on a counter configured to track and indicate the plurality of remote tags are inventoried, wherein the counter is reset based on adjustment of the variable; and determine, based on an absence of a subsequent reply from the one or more remote tags of the plurality of remote tags, the adjusted variable, and the transmit power of the SRD, to complete remote tag inventory tracking associated with an area in an environment.

In some aspects, an apparatus for wireless communication is provided. The apparatus includes: means for determining, based on transmit power of a Short Range Device (SRD), a variable associated with tracking remote tag inventory; means for adjusting the variable based on a reply or absence of the reply from one or more remote tags of a plurality of remote tags; means for adjusting the variable based on a counter configured to track and indicate the plurality of remote tags are inventoried, wherein the counter is reset based on adjustment of the variable; and means for determining, based on an absence of a subsequent reply from the one or more remote tags of the plurality of remote tags, the adjusted variable, and the transmit power of the SRD, to complete remote tag inventory tracking associated with an area in an environment.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

FIG. 1 is a diagram illustrating an example of a radio frequency (RF) energy harvesting device, in accordance with aspects of the disclosure.

FIG. 2 is a diagram illustrating example components of a device, in accordance with aspects of the present disclosure.

FIG. 3 is a diagram illustrating an example of a remote reading system, in accordance with aspects of the present disclosure.

FIG. 4 is a block diagram illustrating an example inventorying process over a period of time, in accordance with aspects of the present disclosure.

FIG. 5 is a flow diagram illustrating an example process for wireless communication, in accordance with aspects of the present disclosure.

FIG. 6 is a line graph illustrating an example relationship between a Q-value and a delta for incrementing and decrementing the Q-value, in accordance with aspects of the present disclosure.

FIG. 7 is a set of line graphs illustrating example inventorying statistics based on a Q-value, in accordance with aspects of the present disclosure.

FIG. 8 is a flowchart diagram illustrating an example of a process for wireless communications, in accordance with aspects of the present disclosure.

FIG. 9 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As mentioned, wireless communication technologies can be classified based on range of technologies. For example, short range wireless communication can enable wireless communication over relatively short distances (e.g., within thirty meters) and long range wireless communication can enable wireless communication over relatively long distances (e.g., more than thirty meters). Remote reading systems, such as Radio Frequency Identification (RFID) systems, are generally classified as short range wireless communication. Remote reading technologies generally provide wireless transfer of data between a reader (e.g., remote reader, or RFID reader) and a tag or transponder (e.g., remote tag or RFID tag). Remote reading systems can be used for identification, tracking, data storage, etc. For example, remote reading systems can be used to identify and/or track various items, such as packages in transit, boxes in warehouses, products on shelves of a store, etc.

A remote tag can be attached to an item to be tracked. Remote tags generally include data storage and an antenna. The data storage stores information corresponding to the associated item. In such an example, the information can include identifiers of the item such as a name, a serial number, manufacturer, etc. The antenna can allow information from the remote tag, or the remote tag, to be read by a remote tag reader, which transmits an interrogating signal to one or more remote tags within communication range. The remote tag reader can power remote tags. For example, the interrogating signal from the remote tag reader can be used to power the remote tag. Other remote tags, such as active or semi-active remote tags can include a power source (e.g., a battery) to power the remote tag.

Remote reading systems, such as Radio Frequency Identification (RFID) systems, can be used for wireless communication between a reader device (e.g., remote tag reader) and one or more tags or transponders (e.g., remote tags). In some examples, the remote tag reader can be or can be a component of a short range device (SRD). For example, an SRD can include a smartphone including a remote tag reader, a tablet including a remote tag reader, etc. A remote tag reader may also be referred to as an “RFID interrogator,” “remote interrogator,” “remote scanner,” and “RFID scanner,” and/or an “energizer.” Remote reading systems can be used to identify and/or track various items that are associated with one or more remote tags (e.g., various items to which one or more remote tags are attached). Remote systems can read and/or write information to and/or from (respectively) remote tags, based on respective wireless communications between a remote tag reader and the remote tags.

For example, a remote tag reader (e.g., energizer) can be used to interrogate one or more remote tags to obtain information of the nearby items that are within communication range of the remote tag reader and the interrogation signal. The remote tag reader (e.g., energizer) can transmit a radio frequency (RF) signal to perform the energizing and interrogating of the remote tags. A remote tag that receives the interrogating RF wave can respond by backscattering (e.g., reflecting back) and/or transmitting another RF wave. A remote tag may generate the responsive RF wave originally (e.g., in examples where the remote tag is an active or semi-active tag). A remote tag may generate the responsive RF wave passively, for instance by reflecting back a portion of the interrogating RF wave using a backscatter process (e.g., in examples where the remote tag is a passive tag).

A remote tag attached to a respective item, or attached to a group of items, can store corresponding information thereof. For example, a remote tag can include a data storage element that stores information corresponding to the item(s) to which the remote tag is attached and associated. For instance, remote tag information can include one or more of a product name, a serial number, product information, a manufacturer, etc. In some examples, the remote tag can store identification information that is directly indicative of a tagged item, product, object, etc. For instance, a remote tag can store identification information such as a unique product serial number, etc. In some examples, the remote tag does not store product or item identification information directly, and stores a unique remote tag serial number or identification number which may be externally mapped to various item identification information such as product serial numbers, product names, product SKUs, etc.

A remote tag reader (e.g., energizer) can transmit an RF signal configured to cause the remote tags to transmit at least a portion of their respective identification information. The remote tag reader can receive (e.g., scan) the identification information transmitted by the one or more remote tags energized by the remote tag reader and can use the identification information to track inventory of tagged items or products that are within range of the RF signal of the remote tag reader (e.g., nearby such as within 30 meters).

Remote reading systems can be used in a warehouse or retail environment for inventory tracking (e.g., determining when remote tags and corresponding products are removed from an area in an environment, a quantity of remote tags and corresponding products in an area, etc.). In another example, remote reading systems can be used to determine the contents of a container, such as a box in a warehouse without opening the box, providing a label of the contents.

Remote tag readers can be configured to read hundreds of remote tags per second, based on the respective remote tags responding to an interrogation signal from the remote tag reader using a corresponding time slot determined for the respective remote tag. The time slot used by a remote tag can be assigned by the remote tag reader or can be determined by the remote tags. For example, remote tags can respond to an interrogation signal based on randomly choosing a time slot within a configured time window for response. In some cases, an anti-collision algorithm can be used to divide a time window into a plurality of discrete time slots for remote tags responses, within which each remote tag can randomly choose or be assigned a particular time slot. Each remote tag transmits its identification information back to the reader in the corresponding or allocated time slot for the remote tag. Restricting each remote tag to a particular time slot reduces the chances of a collision occurring when two or more remote tags attempt to transmit during the same time slot. If a collision occurs, the multiple remote tags attempting to transmit during the same time slot are not successfully read by the remote tag reader and may be configured to select new time slots and retransmit.

In some examples, inventorying multiple remote tags can be a time intensive and resource intensive task. For example, when remote tags are used in a warehouse or retail setting, thousands of boxes or consumer products can be included within range of the remote tag reader for inventorying. Time slots of the remote tags are generally determined at random. With a large plurality of remote tags, the number of collisions generally increases, slowing the inventorying process. Improvements to the inventorying process can reduce the time and resources for performing inventorying.

Remote reading systems generally structure inventorying processes and operations based on an algorithms or protocols for cycling through remote tags for inventorying. For example, remote reading systems configured for Electronic Product Code (EPC) Generation 2 (e.g., Gen2) standards generally use an ALOHA protocol established in the Gen2 standards. In such an example, a remote tag reader is used to power one or more remote tags and applies an anti-collision protocol to disambiguate the remote tags during inventorying. The ALOHA protocol can be used in inventorying to manage remote tag replies to the remote tag reader. In such an example, the remote tag reader can determine a number of opportunities (e.g., time slots or referred to as slots) for the remote tags to respond to interrogatory signals of the remote tag. The ALOHA protocol however generally wastes inventory rounds (e.g., back and forth communication between the remote tag reader and the remote tags). For example, the number of remote tags to be inventoried is high (e.g., 100 or more), the ALOHA protocol can be prone to incorrectly determining no reply (e.g., an absence of a reply) was provided from a remote tag to the remote tag reader. In some examples, an error in determining no reply to the remote tag reader can cause the remote reading system using ALOHA protocol to determine inventorying is complete or can cause the remote reading system to waste resources resolving the error. In another example, when the number of remote tags is low (e.g., 10 or less), the probability of detecting a collision can increase wasting remote reading system resources in adjusting slotting for corresponding remote tags.

Additionally, remote reading systems can adjust range of wireless communication with remote tags by adjusting transmission power (e.g., TX power) of remote tag readers. For example, remote reading systems can include remote tag readers (e.g., energizers) with antenna configurations and transmission power adjustable to limit a reading range or zone within which the remote reading system (e.g., the remote tag reader) can detect and communicate with remote tags.

Systems, apparatuses, electronic devices, methods (also referred to as processes), and computer-readable media (collectively referred to herein as “systems and techniques”) are described herein for wireless communication. For example, the systems and techniques are described herein for inventorying processes using RF communication (such as RFID). In some aspects, the systems and techniques can include operations for improving efficiency in inventorying process (e.g., reducing duplicative actions, reducing computing resources, reducing time for inventorying).

In some aspects, the systems and techniques can include determining a Q-value for inventorying. The Q-value can be a parameter or variable associated with a number of slots to provide to a plurality of remote tags to determine when the remote tags should transmit messages to the remote tag reader. In some examples, the Q-value can be set as Q=round (log₂ N_{tag}) where N_{tag} represents the number of remote tags (or in estimation of the number of remote tags) in the plurality of remote tags. The round() function can represent a function for rounding a value (e.g., log₂ N_{tag}) to a representation of the value in a different data type. For example, the Q-value can be a floating point variable for tracking the remote tag inventory. In some aspects, the systems and techniques can include setting the Q-value to log₂ N_{tag} to reduce a rate of no remote tag reply and to reduce the rate of remote tag collisions. For example, because an exact or estimated number of remote tags within range of a remote tag reader is generally not known or imprecise, collisions can occur due to a lack of available slots. Adjustments to the Q-value as the rate of collisions or no replies (e.g., absence of replies) from the plurality of remote tags can improve efficiency of the remote reading system by reducing the number of collisions without increasing the number of no replies beyond an amount exceeding the saved benefit in computing resources from reducing the number of collisions.

In some examples, a theoretical optimal Q-value can be represented as Q=round(log2(N)). Whether the Q-value is determined to be too high or too low is generally in reference to the optimal Q-value. In such an example, the optimal Q-value generally has a single tag reply rate of 35%-37%, with significant rate of no reply and collision due to underlying probability of each tag randomly choosing slot count. When the Q-value is bigger than the optimal value, no tag replies increase, and single tag reply and collision rates generally reduces. When the Q-value is smaller than the optimal value, then collision rates increase, single tag reply and no tag reply decreases too. Adjusting or setting the Q-value to approximate the theoretical optimal Q-value can be used to maximize a rate of single tag replies when the remote tags reply EPC to the remote tag reader and adjusts a state of the remote tag to an inventoried state.

In some aspects, the systems and techniques can include determining a Q-value for inventorying based on the transmission power (e.g., the initial transmission power) of the remote tag reader. For example, the greater the range of the remote tag reader, the greater the Q-value. In such an example, the Q-value can be a variable or parameter initialized based on the transmission power of the remote tag reader. The Q-value can also be referred to as Q_{fp} when the Q-value is a floating point representation of the Q-value. The Q_{fp} can be a floating number and updated during inventory and finally used to determine what integer Q-value being used during inventory. Transmission power (e.g., TX power) can be associated with RF range in which tags are able to respond to reader (e.g., increases in transmission power can be associated with increases RF range). For example, when the transmission power is doubled, the range of the RF range can be doubled. In such an example, the systems and techniques can include selecting an initial Q-value greater than the previous initial Q-value (e.g., greater than the previous initial Q-value by 1). The systems and techniques can include adjusting the Q-value (e.g., adjusting the variable or parameter associated with the Q-value) based on replies from a remote tag of the plurality of remote tags. For example, when a single remote tag from the plurality of remote tags replies to an interrogatory signal of the remote tag reader, the remote reading system can maintain the value of the Q-value (e.g., Q_{fp}). When no remote tag is detected (e.g., no reply is provided or an absence of a reply), the remote reading system can decrement Q_{fp} (e.g., reduce a value associated with Q_{fp}). When multiple replies are received (e.g., a collision) which is not resolved, the remote reading system can increment Q_{fp} (e.g., increase a value associated with Q_{fp}).

In some aspects, the systems and techniques can include determining whether an adjustment was made to Q_{fp} by adjusting the data type of Q_{fp} and comparing Q_{fp} to a different data type representation of Q_{fp}. For example, the systems and techniques can include using round( ) function to round Q_{fp} to an integer representation of the Q-value. For example, a Q-value of 13.79 can be rounded to 14. The systems and techniques can include using the rounded Q-value to determine an order of the remote tags to reply (e.g., respond to interrogatory signals) to the remote tag reader.

In some aspects, the systems and techniques can include using the rounded Q-value to determine the order of replies of the remote tags based on adjusting slot values of the remote tags. For example, the remote tags can generate a slot value or can be provided a slot value by the remote tag reader. In some examples, the slot value can be a represented as a variable or parameter stored in memory of the remote tag. The slot values of the remote tags can be different.

In some examples, the systems and techniques can include a slot counter stored in tag memory. Each remote tag can select a random number from 0 to 2^{Q}−1 based on a Query cmd including the Q-value. Upon receiving a QueryRep, the remote tag will decrement its slot counter and/or Q-value by 1. Remote tags can have a slot value=0 can reply to the remote tag reader and send back RN16 for ACK/EPC. Whenever a Query Adjust command is received, each remote tag not inventoried can select a different slot counter/value with an updated Q-value from 0 to 2^{Q}−1) and can repeat the process of selecting Q-values.

In some examples, the slot values can be a random number within a predetermined range of values (e.g., 1 to the Q-value, 0 to the Q-value, etc.). For example, the remote tag can include a random number generator (RNG) and select (e.g., generate to use as slot values) a random number from 0 to 2^{Q}−1. When the Q-value is changed (e.g., from a Query cmd or Query Adjust cmd), the slot values of the remote tags (or one of the remote tags from the plurality of remote tags such as the non-inventoried remote tags) can be adjusted. In another examples, the systems and techniques can include executing a query adjust command (e.g., QueryAdjust) based on adjustment criteria (also referred to as adjustment conditions or early adjustment criteria). In some examples, adjustment criteria can be based on an algorithm. In such an example of an algorithm, QueryRep and QueryAdjust can be transmitted to remote tags in various orders. For example, the adjustment criteria can be based on remote tag reply statistics. For example, the remote tag reply statistics can be a probability associated with a collision or a no reply from the remote tags at a time slot.

In some aspects, the systems and techniques can use an algorithm to increment or decrement Q_{fp} (or other Q-value) during inventorying processes and determine whether to adjust the Q_{fp}. When a Q value greater than a Q-value threshold (e.g., the Q-value threshold can represent Q-values outside of a range of Q-values associated with a predicted optimal Q-value), the systems and techniques can include using remote tag reply statistics and may indicate whether to adjust Q-values before using the algorithm to increment or decrement the Q-value. Remote tag reply statistics can include a number or rate of single replies, no replies, and collisions using an updated Q-values.

In further examples, when the Q-value is +/−1 from an optimal Q-value, the rate of single tag replies can be degraded (e.g., dropped from ~36% to ~30%). When the Q-value deviates from the optimal Q-value by greater than 1, the rate of single tag replies can be further degraded. In such an example, early adjustment of the Q-value can increase single tag reply rates. For example, the systems and techniques can include counting collisions on first eight slots of remote tag replies. When no collision occurs, the systems and techniques can include decrementing Q value by 1 (e.g., using Query Adjust-1). When a collision is detected, the systems and techniques can include counting remote tag collisions until the systems and techniques detect two collisions or twelve time slots. When only one collision is detected within the first twelve slots, the systems and techniques can decrement Q-value by 1. In scenarios where Q=optimal Q+2, the average rate of collisions can be roughly 3%, while average rate of collisions is roughly 28% with optimal Q.

In such an example, the probability of either no collision in first eight time slots or 1 collision in first eight time slots and only 1 collision in first twelve slots can be represented as: (1-rate_collision)^8+8*rate_collision*(1-rate_collision)^11 where rate_collision represents a rate of collisions of remote tag replies.

In another example, early adjustments to the Q-value can include incrementing the Q-value. In such an example, when the systems and techniques determine a no tag reply for time slot within the first eight time slots, the systems and techniques can increment Q value by 1 (e.g., using Query Adjust+1). In such an example, the probability of a no remote tag reply can be represented as (1-rate_no_tag)^8+8*rate_no_tag*(1-rate_no_tag)^11 where rate_no_tag represents a rate that a remote tag does not reply at a time slot. When no tag is detected, the systems and techniques can continue to count additional no tag replies for time slots until two no tag replies are detected, or twelve time slots indicate remote tag replies. In such an example, when only 1 no tag reply is determined with the first twelve time slots, the systems and techniques can increment the Q-value by 1. In some examples, a machine learning algorithm can be used to determine remote tag response patters and determine additional early adjustment to Q-values.

In some aspects, the systems and techniques can include adjusting the slot value (e.g., when the Q-value changes or the adjustment criteria are met. For example, the slot value can be adjusted based on the equation slot value=2^{Q}−1 where Q is the rounded Q-value. In such an example, when a new Q-value (e.g., an updated Q-value) is sent to remote tags, remote tags can choose a slot counter value in range 0 to 2^{Q}−1 (total 2^{Q} values). After the Q-value is sent, a remote tag reader can determine whether a remote tag has a value of 0 and can decrement the value by 1 using a QueryRep cmd. In such an example, after QueryRep is sent out for 2^{Q} times, each remote tag should have participated in this inventory (e.g., because the total number of values can be 2^{Q} values). The collided remote tags are missed and cannot participate when continuing to use QueryRep. The systems and techniques can include using a counter just to track collisions and when the algorithm has performed 2^{Q} consecutive QueryRep associated with a current Q value, the algorithm can adjust the counter. In such an example, the algorithm can send a Query Adjust using the same Q-value.

The systems and techniques can use the slot value (e.g., the slot number) to track termination of remote tags when inventorying. For example, the systems and techniques can track a number of QueryRep transmitted including a predetermined Q-value, and trigger (based on the number of QueryRep commands) a Query Adjust. When the slot value equals 0 (e.g., Slot value==0), all remote tags participated in the inventory process with unresolved collisions. For example, when QueryRep has been repeated for 2^{Q} times with a current Q value, all remote tags participated in the inventory process with unresolved collisions. In such an example, the systems and techniques can include generating a Query Adjust command with the current Q-value (e.g., the rounded Q-value) to resolve a previous collision. When the slot value does not equal 0, the Q did not change, and the adjustment criteria were not met, can decrement the slot value when the QueryRep command is transmitted. In some examples, the slot value can be decremented each time a QueryRep command is transmitted or received.

The systems and techniques can include determining an inventory command. For example, when no subsequent remote tags reply to interrogatory signals of the remote tag reader, the Q-value equals 0, and the transmission power of the remote tag reader is outputting at or above a transmission power threshold, the systems and techniques can determine the inventorying process is complete. When the Q-value is not equal to 0, Q_{fp} can be decremented. For example, Q_{fp} can be adjusted based on Q_{fp}=max(0, Q_{fp}−D_{dec}). D_{dec} can represent an adaptive decrement step to Q_{fp}. When the systems and techniques detect a collision, (e.g., more than one remote tag replies in a time slot), Q_{fp} can be incremented. For example, Q_{fp} can be adjusted based on Q_{fp}=min (15, Q_{fp}+D_{inc}). D_{inc} can represent an adaptive increment step to Q_{fp}. In some aspects, when one remote tag replies at a time slot, the systems and techniques can include maintaining the Q_{fp} value, represented by the equation Q_{fp}=Q_{fp}+0. In one example, the decremental step and the incremental step can be represented as a ratio. In such an example, the ratio of the decremental step and the incremental step can be based on a determined rate of failed remote tag detection and a determined rate of collision of replies of the plurality of remote tags.

The amount Q_{fp} is incremented or decremented (e.g., D_{inc} and D_{dec}) can be adaptive based on the value of Q_{fp} or the rounded integer representation of Q_{fp}. For example, D_{dec} can increase as Q_{fp} increases. In further examples, D_{inc} and D_{dec} can be different values. In such an example, the systems and techniques can decrement Q_{fp} at greater step values than incrementing Q_{fp}.

For example, the systems and techniques can include adjusting Q_{fp} based on remote tag reply cases (e.g., empty, reply, collision). Q_{fp} can suggest adjustment of Q value used by remote tags. After each adjustment of Q, we also keep track or adjust internal “counter” variable. adjust Q_{fp} and Q=round(Q_{fp}) based on the counter indicating the remote tags are inventoried and reset the counter based on the Q.

Further aspects of the systems and techniques will be described with reference to the figures.

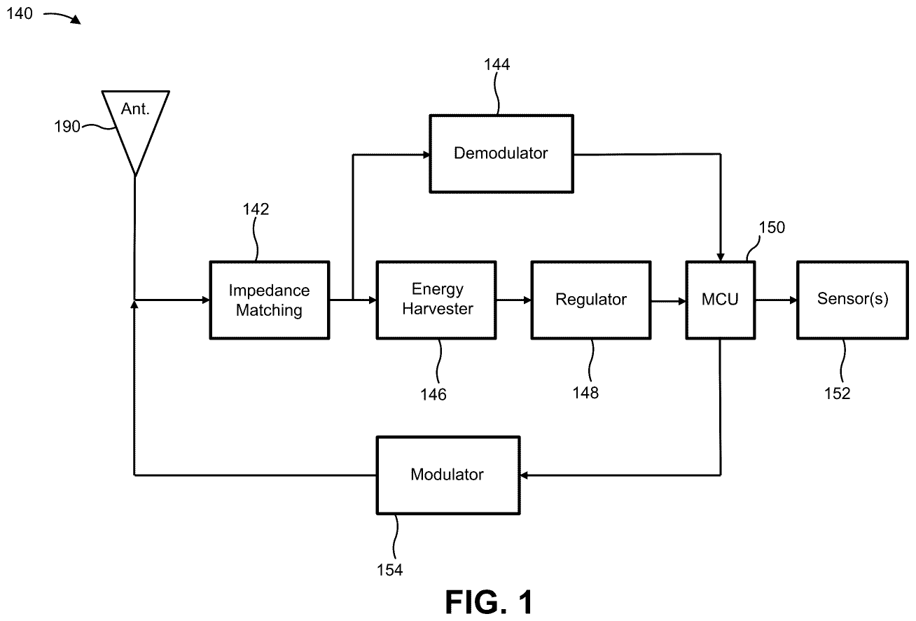

FIG. 1 is a diagram illustrating an example of an architecture of a radio frequency (RF) energy harvesting device 140, in accordance with some examples. As will be described in greater depth below, the RF energy harvesting device 140 can harvest RF energy from one or more RF signals received using one or more antennas 190. As used herein, the term “energy harvesting” may be used interchangeably with “power harvesting.” In some aspects, energy harvesting device 140 can be implemented as an Internet-of-Things (IOT) device, can be implemented as a sensor, etc., as will be described in greater depth below. In other examples, energy harvesting device 140 can be implemented as a remote tag, such as a Radio-Frequency Identification (RFID) tag or various other RFID devices.

The energy harvesting device 140 includes the one or more antennas 190 that can be used to transmit and receive one or more wireless signals. For example, energy harvesting device 140 can use antenna(s) 190 to receive one or more downlink signals and to transmit one or more uplink signals. An impedance matching component 142 can be used to match the impedance of antenna(s) 190 to the impedance of one or more (or all) of the receive components included in energy harvesting device 140. In some examples, the receive components of energy harvesting device 140 can include a demodulator 144 (e.g., for demodulating a received downlink signal), an energy harvester 146 (e.g., for harvesting RF energy from the received downlink signal), a regulator 148, a micro-controller unit (MCU) 150, a modulator 154 (e.g., for generating an uplink signal). In some cases, the receive components of energy harvesting device 140 may further include one or more sensors 152.

The downlink signals can be received from one or more transmitters. For example, energy harvesting device 140 may receive a downlink signal from a network node or network entity that is included in a same wireless network as the energy harvesting device 140. In some cases, the network entity can be a base station, gNB, etc., that communicates with the energy harvesting device 140 using a cellular communication network. For example, the cellular communication network can be implemented according to the 3G, 4G, 5G, 6G, and/or other cellular standard (e.g., including future standards such as 6G and beyond).

In some cases, energy harvesting device 140 can be implemented as a passive or semi-passive energy harvesting device (e.g., an ambient energy harvesting device), which can perform passive uplink communication by modulating and reflecting a downlink signal received via antenna(s) 190. For example, passive and semi-passive energy harvesting devices may be unable to generate and transmit an uplink signal without first receiving a downlink signal that can be modulated and reflected. In other examples, energy harvesting device 140 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

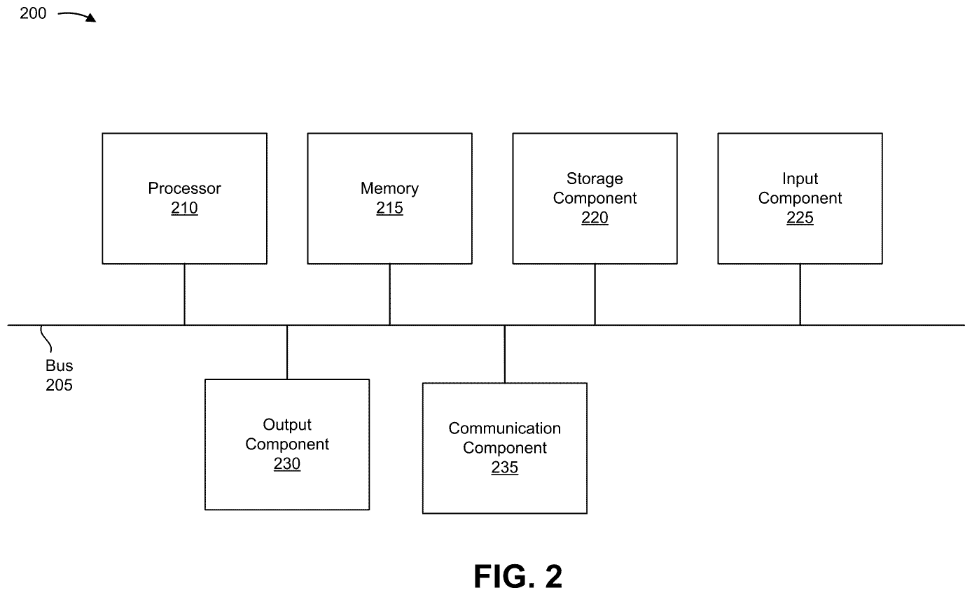

FIG. 2 is a diagram illustrating example components of a device 200, in accordance with the present disclosure. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™M network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

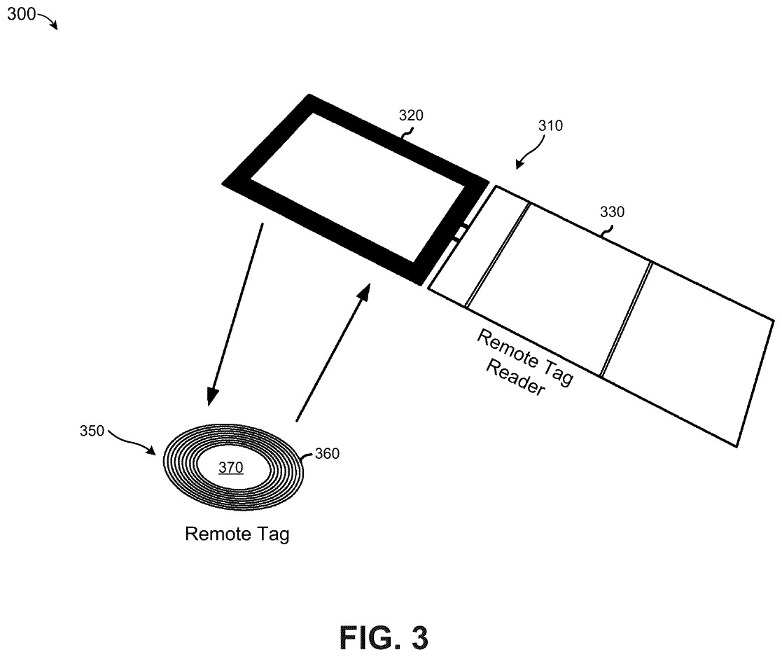

FIG. 3 is a diagram illustrating an example remote reading system 300 that includes a remote tag reader (e.g., energizer) 310 and a remote tag 350. Remote tag reader 310 may also be referred to as an interrogator, a scanner, an energizer, etc. Remote tag 350 may also be referred to as an RF label, an RFID label, an electronics label, etc.

Remote tag reader 310 includes an antenna 320 and an electronics unit 330. Antenna 320 radiates signals transmitted by remote tag reader 310 and receives signals from remote tags (e.g., such as the remote tag 350) and/or other devices. Electronics unit 330 may include a transmitter and a receiver for reading remote tags such as remote tag 350. The same pair of transmitter and receiver (or another pair of transmitter and receiver) may support bi-directional communication with wireless networks, wireless devices, etc. In some examples, a first remote tag reader or SRD can include a transmitter for energizing one or more remote tags, and a second remote tag reader or SRD can include a receiver for receiving the reflected signals from the one or more remote tags. For instance, a remote tag reader can be configured to implement energizing and tag reading capabilities (e.g., includes a transmitter and a receiver), can be configured to implement energizing capabilities (e.g., includes a transmitter), and/or can be configured to implement tag reading capabilities (e.g., includes a receiver). The electronics unit 330 may include processing circuitry (e.g., a processor) to perform processing for data being transmitted and received by remote tag reader 310.

Remote tag 350 includes an antenna 360 and a data storage element 370. Antenna 360 radiates signals transmitted by remote tag 350 and receives signals from remote tag reader 310 and/or other devices. For instance, remote tags can be passive, active, or semi-active. Passive remote tags utilize the interrogating signal from a remote tag reader to power a transmission by or from the remote tag. Active and semi-active remote tags can include a power source or battery, which can be used to power a transmission by or from the remote tag. In some examples, the remote tag 350 may be a passive remote tag having no battery. In this case, a magnetic field from a signal transmitted by remote tag reader 310 (e.g., an energizing or interrogating signal from the remote tag reader 310) may induce an electrical current in remote tag 350, which may then operate based on the induced current. Remote tag 350 can radiate its signal in response to receiving a signal from remote tag reader 310 or some other device.

The remote tag 350 can use the data storage element 370 to store identification information corresponding to the remote tag 350 and/or corresponding to an item associated with the remote tag 350 (e.g., an item to which the remote tag 350 is attached, etc.). For example, data storage element 370 can be used to store identification information using various granularity levels for tracking and management of a remote tagged item. A remote tag attached to a respective item, or attached to a group of items, may store corresponding information thereof. For example, the remote tag 350 can be configured to store, using data storage element 370, identification information corresponding to the item(s) to which the remote tag 350 is attached and associated. For instance, remote tag information can include one or more of a product name, a serial number, product information, a manufacturer, etc. In some examples, the remote tag 350 can store (e.g., using the data storage element 370) identification information that is directly indicative of a tagged item, product, object, etc. For instance, the remote tag 350 can store identification information such as a unique product serial number, etc. In some examples, the remote tag 350 does not store product or item identification information directly, and stores a unique remote tag serial number or identification number corresponding to the remote tag 350, which may be externally mapped to various item identification information such as product serial numbers, product names, product SKUs, etc.

Data storage element 370 can be configured to store identification information for remote tag 350, e.g., in an electrically erasable programmable read-only memory (EEPROM). Remote tag 350 may also include an electronics unit that can process the received signal and generate the signals to be transmitted.

Remote tag 350 may be read as follows. Remote tag reader 310 may be placed or moved within close proximity to remote tag 350. Remote tag reader 310 may radiate a first signal (which is also called an interrogation signal) via its antenna 320. The energy of the first signal may be coupled from remote tag reader antenna 320 to remote tag antenna 360 via magnetic coupling and/or other phenomena. Remote tag 350 may receive the first signal from remote tag reader 310 via antenna 360 and, in response, may radiate a second signal (which is also referred to as a responding signal) comprising the information stored in data storage element 370. Remote tag reader 310 may receive the second signal from remote tag 350 via antenna 320 and may process the received signal to obtain the information sent in the second signal.

Remote reading system 300 may be designed to operate at various frequencies and/or frequency ranges. For example, remote reading system 300 can operate at 900 MHz, within a range of 860-960 MHz, etc., among various other example frequencies and/or frequency ranges of remote reading operations. Remote tag reader 310 may have a specified maximum transmit power level, which may be imposed by the Federal Communication Commission (FCC) in the United Stated or other regulatory bodies in other countries. The specified maximum transmit power level of remote tag reader 310 limits the distance at which remote tag 350 can be read by remote tag reader 310.

As noted previously, the systems and techniques described herein can be used to perform remote tag localization based on using a plurality of remote tag reader devices with mutually exclusive (e.g., orthogonal) and synchronized carrier frequency hopping sequences that can be used by each remote tag reader device to obtain a respective set of PBR or other phase measurement information at a plurality of carrier frequencies. The synchronized remote tag readers can obtain a plurality of phase change or other phase measurements that can be used to determine a respective distance between the remote tag and each remote tag reader, for example using phase-based ranging techniques (e.g., PBR-based distance estimation, etc.). The respective distance from the remote tag to each remote tag reader can be analyzed and used to perform 2D or 3D localization of the remote tag, and/or can be used to perform selective reading of remote tags and remote tag identification information corresponding to collected items of a container, such as a shopper's basket (e.g., also referred to as “basket contents”). The systems and techniques can perform PBR-based remote tag localization using the synchronized carrier frequency hopping (e.g., channel hopping) sequences and/or can be used to perform selective remote tag reading to determine, generate, and/or update item inventory information corresponding to the selectively read remote tags. In one illustrative example, the item inventory information of selectively read remote tags can correspond to remote tagged items that are within the container (e.g., the shopper's basket).

In some aspects, a remote tag reader can perform channel hopping to switch between a plurality of different carrier frequencies during the transmission of a tone signal to the remote tag. The remote tag can backscatter a modulated tone signal at each respective carrier frequency of the plurality of different carrier frequencies during the transmission from the remote tag reader, and the remote tag reader can determine a respective phase measurement (e.g., phase change measurement) and/or can determine relative phase information for each carrier frequency of the plurality of different carrier frequencies.

In some aspects, RF communications can be performed between a remote tag reader and one or more remote tags of a plurality of remote tags (e.g., remote tags attached to corresponding items, also referred to as “remote tagged items”). The RF communications may include one or more RF measurements such as phase-based ranging (PBR) measurements, Received Signal Strength Indicator (RSSI) measurements, and/or various combinations thereof. PBR measurements can be performed between a remote tag reader device and a remote tag, where the remote tag reader device is configured to transmit an energizing or interrogating signal and the remote tag is configured to reflect the interrogating signal as a backscatter signal (e.g., also referred to as a “reflected signal” and/or “reply signal”).

For illustrative purposes, examples are described herein using a shopper's “basket” as an illustrative example of a container. However, the systems and techniques also apply to any other type of container. A shopper's “basket” (or container) can refer to any receptacle or volume within which items are placed for temporary storage and/or transport (e.g., prior to purchase or other use). For example, a shopper's “basket” can include various implementations, such as a handheld-basket, a cart or trolley, a bag or satchel, etc. A shopper's “basket” or “basket contents” may also refer to the hand carry of one or more items by a shopper.

In some aspects, RF measurements can be performed with a plurality of remote tags (e.g., remote tags attached to corresponding items, also referred to as “remote tagged items”). The RF measurements can include phase-based ranging (PBR) measurements, Received Signal Strength Indicator (RSSI) measurements, and/or various combinations thereof. PBR measurements can be performed between a remote tag reader device and a remote tag, where the remote tag reader device is configured to transmit an energizing or interrogating signal and the remote tag is configured to reflect the interrogating signal as a backscatter signal (e.g., also referred to as a “reflected signal” and/or “reply signal”).

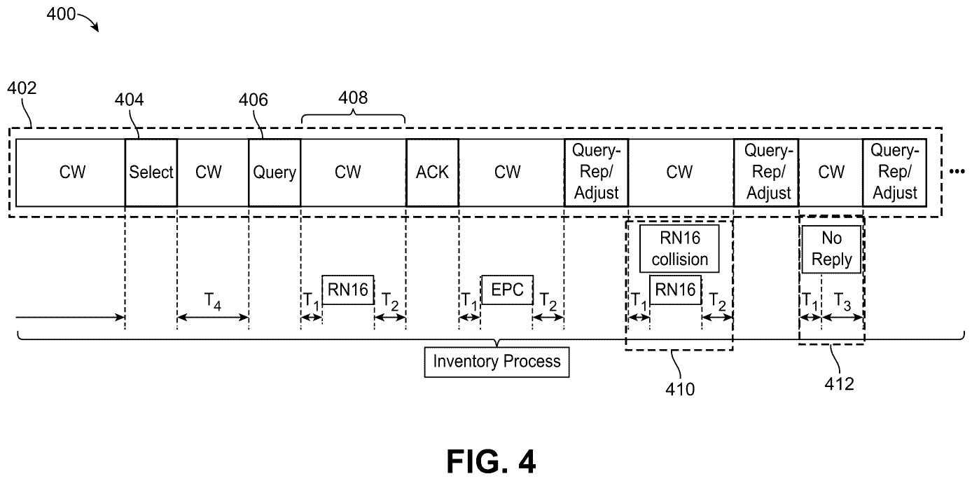

FIG. 4 is a block diagram 400 illustrating an example inventorying process over a period of time. The block diagram 400 illustrates a remote tag reader 402 in communication with a plurality of remote tags. The remote tag reader 402 can generate a command such as query 406 requesting response from a first remote tag 404. In some examples, the remote tag reader 402 transmits the query 406 to a plurality of remote tags. In such an example, the first remote tag (e.g., the first remote tag 404) associated with time slot 408 can respond to the remote tag reader 402 (e.g., a reply such as an RN16 message representing a 16-bit random number). The remote tag reader 402 can generate and transmit an acknowledgement message in response to the message from the remote tag 404 (e.g., by repeating the RN16 back to the remote tag 404). In one example, the remote tags can set a slot counter after receiving Query or QueryAdjust commands, and decrement the slot counter after receiving a QueryRep command.

When the remote tag 404 receives confirmation that the message was received by the remote tag reader (e.g., by receiving and processing the acknowledgement message), the remote tag 404 can transmit information corresponding to the remote tag 404 (e.g., EPC information). The remote tag reader 402 can process the EPC information and inventory the remote tag 404 (e.g., store in memory data indicating the remote tag 404 has been detected and inventoried).

FIG. 4 further illustrates an example collision 410. The collision 410 can occur when the remote tag reader 402 receives messages from multiple remote tags during the same time slot. FIG. 4 further illustrates an example no reply 412 (e.g., absence of a reply from remote tags). In such an example, no remote tags provide a reply to the remote tag reader 402 during the time slot.

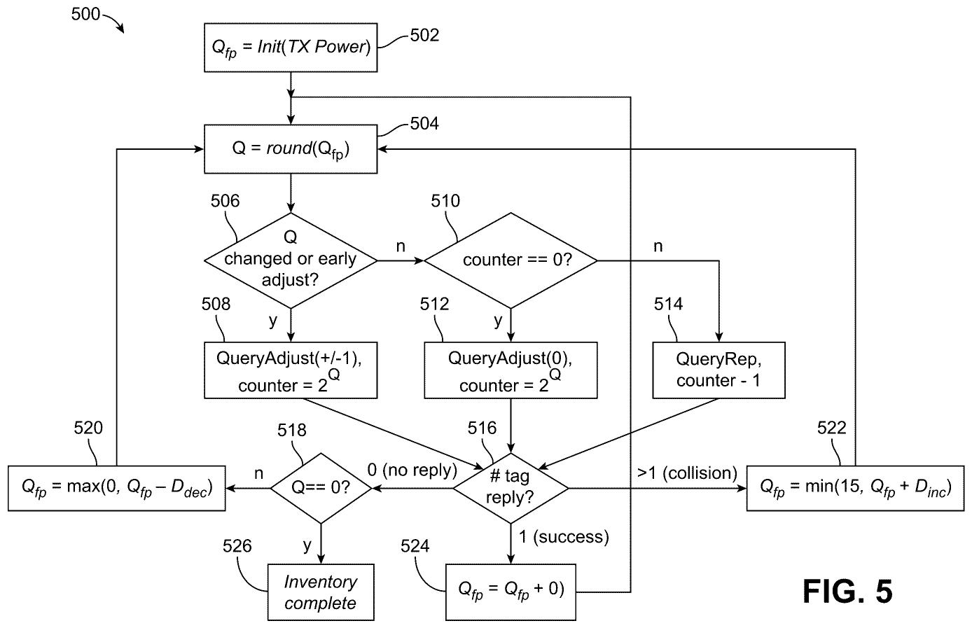

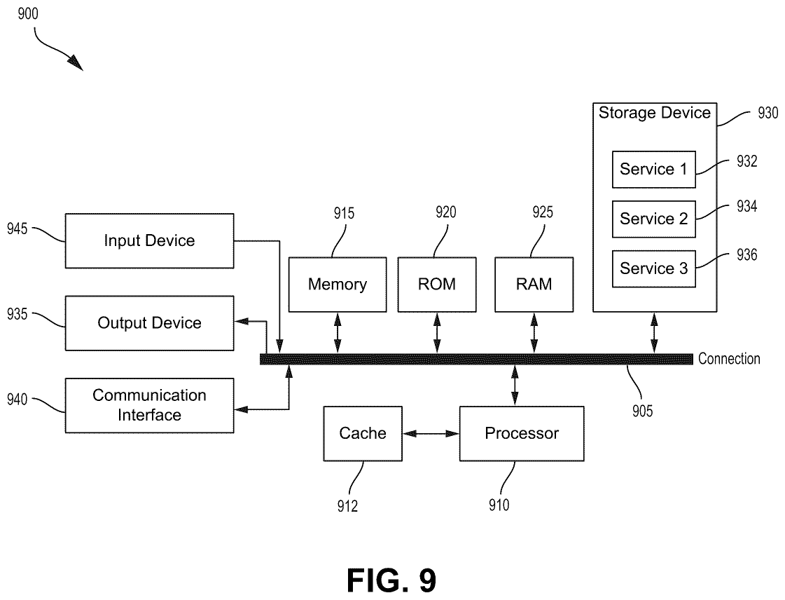

FIG. 5 is a flow diagram illustrating an example process 500 for wireless communication. In particular, the process 500 illustrates an example process of inventorying remote tags, such as the remote tag 350 of FIG. 3 or the remote tag described in communication with the remote tag reader 402 in the description of FIG. 4. The process 500 can be performed by a computing device (e.g., the device 200 of FIG. 2, the remote tag reader 310 of FIG. 3, the remote tag reader 402 of FIG. 4, the computing device or computing system 900 of FIG. 9, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 500 can be implemented as software components that are executed and run on one or more processors (e.g., processor 210 of FIG. 2, the processor 910 of FIG. 9, or other processor(s)) of the computing device. Further, the transmission and reception of signals by the computing device in the process 500 can be enabled, for example, by one or more antennas and/or one or more transceivers (e.g., wireless transceiver(s)).

At block 502, a computing device (or component thereof) can initialize a Q-value for inventorying. For example, the computing device initialize the Q-value to provide to remote tags during an inventorying process. The remote tags can randomly pick a value from 0 to 2^{Q}−1 and store the random value as a slot counter. The computing device can initialize the Q-value based on transmission power of a remote tag reader. For example, the Q-value can increase based on increases in the transmission power of the remote tag reader. The Q-value can also be referred to as Q_{fp} when the Q-value is a floating point representation of the Q-value. In such an example, Q_{fp} can be represented by the equation Q_{fp} =Init (TXPower) with TXPower representing transmission power of the remote tag reader. The Init( ) function can be used to set an initial value of Q_{fp}.

The Q-value can be a parameter or variable associated with a number of slots to provide to a plurality of remote tags to determine when the remote tags should transmit messages to the remote tag reader. In one example, where the Q-value can be an integer value from 0-15. Q_{fp} can be an internal variable based on an algorithm for tracking Q-values. In some examples, the initialization of the Q-value at block 502 can occur before the remote tags are inventoried by the remote tag reader. In further examples, the Q-value can be reinitialized based on a command from the computing device or the remote tag reader, due to a loss of power to the computing device or reader, or due to a change in transmission power of the remote tag reader (e.g., a change exceeding a predetermined threshold of change in transmission power).

In some examples, the Q-value can be initialized based on the transmission power of the remote tag reader, the range of the remote tag reader, and an estimated number of tags within range of the remote tag reader. For example, the Q-value can be initialized to Q=round (log₂ N_{tag}). In such an example, N_{tag} can represent an expected or estimated number of remote tags within range of the remote tag reader. In an example where only one remote tag is expected, Q can be initialized to 0. A user can place the remote tag reader in range of the remote tag to fetch EPC information. The computing device can perform an inventory search based on the EPC. For example, the computing device can apply the EPC as a filter to access the remote tag.

At block 504, the computing device (or component thereof) can include determining an adjustment has been made to the Q-value (e.g., an adjustment to Q_{fp}). The computing device can use a round() function (also referred to as the round function) to determine whether an adjustment was made to Q_{fp}. The For example, the round function can adjust the data type of Q_{fp} and round the different data type representation of Q_{fp} to a nearest integer value. The different data type representation of Q_{fp} can be represented as Q, such as in the equation Q=round (Q_{fp}). In such an example Q can be an integer representation of the floating point variable Q_{fp}. For example, the computing device can use round() function to round Q_{fp} to an integer representation of the Q-value. In such an example, a Q-value of 13.19 can be rounded to 13. In some examples, the round function can exclusively round up. In such an example, a Q-value of 13.19 can be rounded to 14. Adjustments can be made to the Q-value at block 520 and block 522, further described below.

In an example where Q_{fp} has been initialized and the SRD (or remote tag reader) has not yet communicated with remote tags, the Q-value can be the same (e.g., no adjustment to Q_{fp}). In some examples, the rounded Q-value can be used to determine an order (e.g., temporal order) in which remote tags of a plurality of remote tags should reply to interrogatory signals of the remote tag reader. In some examples, the counters can be a random number within a predetermined range of values (e.g., 0 to 2^{Q}, etc.). Q_{fp} can be an internal variable of the algorithm for tracking Q-values. In such an example, the algorithm can adjust Q_{fp} based on remote tag reply during inventory. When round(Q_{fp}) is a different integer value from a current Q-value which is protocol defined and used in inventory, the remote tag reader can use the round(Q_{fp}) and internally to the protocol can set Q_{fp} to an updated value.

At block 506, the computing device (or component thereof) can determine whether the Q-value has changed (e.g., whether an adjustment has been made to the Q-value) or if the adjustment conditions (e.g., early adjustment conditions) are fulfilled. For example, the adjustment conditions can be associated with remote tag collision statistics, no reply statistics, and other inventorying process statistics. In such an example, an inventorying process statistic can include a rate or probability of remote tag collision based on the Q-value or collected data during the process 500. In such an example, when remote tag collision rates increase to exceed a predetermined threshold, the adjustment condition can be fulfilled. When either the Q-value is changed or the adjustment condition is fulfilled (e.g., met or exceeded), the process 500 can advance to block 508.

When the Q-value is not changed and the adjustment condition is not fulfilled, the process can advance to block 510. At block 510, the computing device (or component thereof) can determine whether a counter of the process 500 used for tracking remote tag inventorying is equal to 0 (e.g., whether all tags have participated in the inventorying process with unresolved collision). When the counter equals 0, the process 500 can advance to block 512. When the counter does not equal 0, the process 500 can advance to block 514.

At block 508, block 512, and block 514, the computing device can adjust a counter associated with the number of QueryRep transmitted for a current Q-value to decrement the counter. When the number of QueryRep commands is more than 2^{Q}, no additional QueryRep commands are needed to decrement the counter. In such an example, a Query Adjust with no Q-value change can be transmitted to refresh the counter for un-inventoried remote tags (e.g., the remote tags which were not inventoried because of collisions, no tag replies, etc.).

For example, at block 508, the computing device can provide a QueryAdjust command to a remote tag and adjust the counter of the remote tag based on the equation counter=2^{Q} where Q is the rounded Q-value. For example, the remote tags can receive initial Q value from Query command. A QueryAdjust command can include a field indicating remote tags to use same Q, or increment/decrement Q by 1. After the Q-value is adjusted, un-resolved remote tags can generate (e.g., redraw) a random number from 0 to 2^{Q} and load the values in remote tag slot counter memory.

At block 512, the computing device can provide a QueryAdjust command to a remote tag and adjust the slot value of the remote tag based on the equation counter=2^{Q} where Q is the rounded Q-value. At block 514, the computing device can provide a QueryRep command or message to the remote tag to decrement the counter by 1.

The process 500 can advance to block 516 from block 508, block 510, and block 512. At block 516, the computing device (or component thereof) can detect whether a remote tag has provided a reply (e.g., a reply associated with a time slot of the remote tag reader). The process 500 can advance to block 518 when no remote tag replies during the time slot (e.g., a no reply or absence of a reply), to block 524 when one remote tag replies during the time slot, or to block 522 when more than one remote tag replies during the slot (e.g., a collision).

At block 518 the computing device determines whether the Q-value equals 0. When the Q-value equals 0 and the remote tag reader is operating at or above a predetermined transmission power, the process 500 can advance to block 526 to complete the inventorying process. When Q does not equal 0, the process 500 can advance to block 520. At block 520, the computing device (or component thereof) can decrement the Q-value based on the equation Q_{fp}=max(0, Q_{fp}−D_{dec}). In such an example, D_{dec} can be an adjustable (e.g., adaptive or dynamic) value based on the Q-value. For example, a greater Q-value can be associated with a smaller D_{dec}. For example, the computing device can decrement the Q-value at a greater step value when the Q-value is lower as opposed to when the Q-value is higher. In such an example, D_{dec} can be proportional to the Q-value (e.g., Q_{fp}). The process can advance to block 504 from block 520 to iterate through one or more of blocks 504-524 until advancing to block 526 when inventorying is complete.

At block 522, the computing device can increment the Q-value based on the equation Q_{fp}=min(15, Q_{fp}+D_{inc}). In such an example, the D_{inc} can be an adjustable (e.g., adaptive or dynamic) value based on the Q-value. For example, a greater Q-value can be associated with a smaller D_{inc}. The computing device can increment the Q-value at a greater step value when the Q-value is lower as opposed to when the Q-value is higher. In such an example, D_{inc} can be proportional to the Q-value (e.g., Q_{fp}). In some examples, D_{inc} and D_{dec} can be different values. In such an example, the computing device can increment Q_{fp} at lower step values than the computing device decrements Q_{fp} (or vice versa). The process 500 can advance from block 522 to block 504 to iterate through one or more of blocks 504-524 until advancing to block 526 when inventorying is complete.

At block 524, the computing device can maintain the Q_{fp} value. The process 500 can advance from block 524 to block 504 to iterate through one or more of blocks 504-524 until advancing to block 526 when inventorying is complete (e.g., when the Q-value equals 0, no subsequent replies are received, and the transmission power meets or exceed a predetermined transmission power threshold

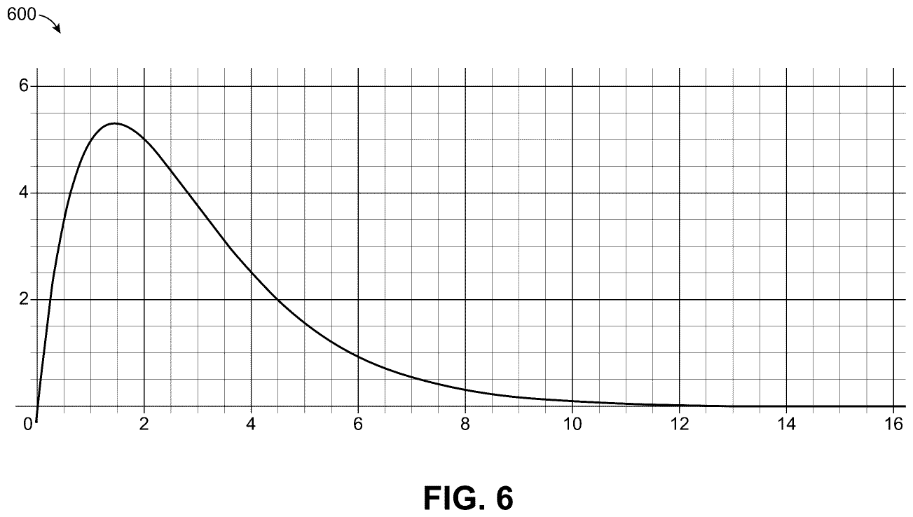

FIG. 6 is a line graph 600 illustrating an example relationship between Q-value (x-axis) and a delta (y-axis) to be used to determine a step size for incrementing and decrementing the Q-value (e.g., incrementing as described in the description of block 520 and decrementing as described in the description of block 522 of FIG. 5). The delta can be adaptive (e.g., dynamic) based on a current Q-value. For example, when the Q-value is large, a small delta can be used. When the Q-value is small, a large delta can be used. In such an example, the step size in estimating the number of remote tags to be inventoried can be represented as 2^{(Q}^{_{fp}}^{+D)}−2^{Q}^{_{fp}}=2^{Q}^{_{fp}}−2^{(Q}^{_{fp}}^{-D)}=constant step size in number of Tags estimation. In some examples, a computing device can use first order Taylor approximations to estimate the step size in the number of remote tags to be inventoried. In one example, as illustrated in the line graph 600, the delta can be represented as D=const*Q_{fp}/2^{Q}^{_{fp}}. In some examples, the D=const*Q_{fp}/2^{Q}^{_{fp}} equation can be stored as a lookup table of the computing device or remote tag reader to determine the delta size (e.g., the amount to increment or decrement Q_{fp} during the inventorying process). In further examples, the computing device can use local linear interpolation for sections of Q_{fp} (e.g., a linear line for Q_{fp} from 2-4, 4-6, 6-8) to determine the delta.

In some examples, the increment step size D_{inc} can be different from decrement step size D_{dec}. For example, when the Q-value=round(log₂ N_{tag}), D_{inc} and D_{dec} can be maintained at a proportional to each other based on the equation rate_no_tag*D_{dec}=rate_collision*D_{inc} where rate_no_tag is associated with a rate of no reply (e.g., absence of a reply) is received from a remote tag and rate_collision is associated with a rate of collisions (e.g., multiple remote tags communicating in the same time slot). The proportion of D_{inc} and D_{dec} can generally be maintained when QueryAdjust is sent during the inventory and with only 2^{Q} remote tags left to inventoried.

For example, for any 2^{Q} remote tags, the rate_no_tag is 1/e, the rate_single_tag is 1/e (e.g., rate or probability associated with one remote tag being communicating with the remote tag reader for a time slot), and the rate_collision is 1-2/e. In such an example, rate_collison: rate_no_tag=e−2≈0.72. When assuming a zero collision resolution assumption, D_{dec}=0.72*D_{inc}. The zero collision resolution assumption can assume that when two remote tags have chosen same random number and the two remote tags respond to reader at the same slot and this is a collision to reader. In such an example, the remote tag reader may generally have no chance to successfully decode one of tag and further determine the remote tag EPC. In such an example, the failure to inventory the remote tag is assumed.

When the computing device has a higher collision resolution, rate_collision reduces, and the rate_no_tag is maintained. The computing device or remote tag reader can track statistics of the inventorying process such as the rate_collision_resolved (success rate of collision resolved) after Query Adjust commands. In some examples, D_{inc} can equal the delta D. In such an example D_{dec} can be represented as D_{dec}=0.72*(1−rate_collision_resolved)*D. In such an example, the higher success rate of collision resolved, the smaller D_{dec} as illustrated by the previous equation.

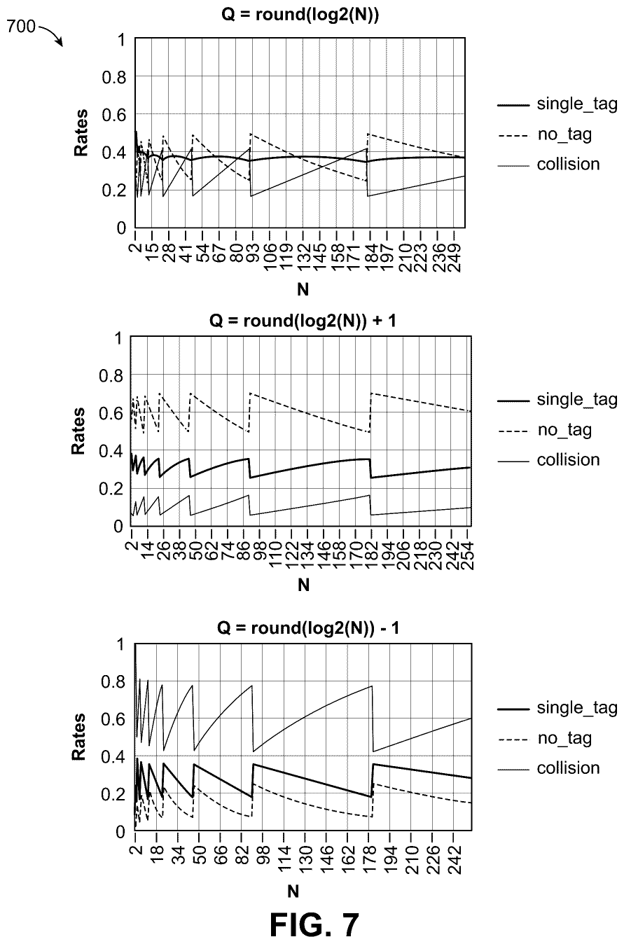

FIG. 7 is a set of line graphs 700 illustrating example rates for single remote tag replies (e.g., when only one remote tag communicates during a time slot), no tag detected (e.g., absence of a reply from a remote tag during a time slot), and collision rates (e.g., when more than one remote tag communicates during a time slot) based on the Q-value. For example, FIG. 7 illustrates the relationship between Q-values and the rates of single remote tag replies, rates of no replies, and collision rates. As shown in FIG. 7, an increase or decrease in the Q-value can adjust the rates of single remote tag replies, rates of no replies, and collision rates. The statistics (e.g., the rates) can be tracked by the computing device or the remote tag reader to determine whether adjustment conditions (e.g., as further described in the description of block 506 of FIG. 5) have been fulfilled.

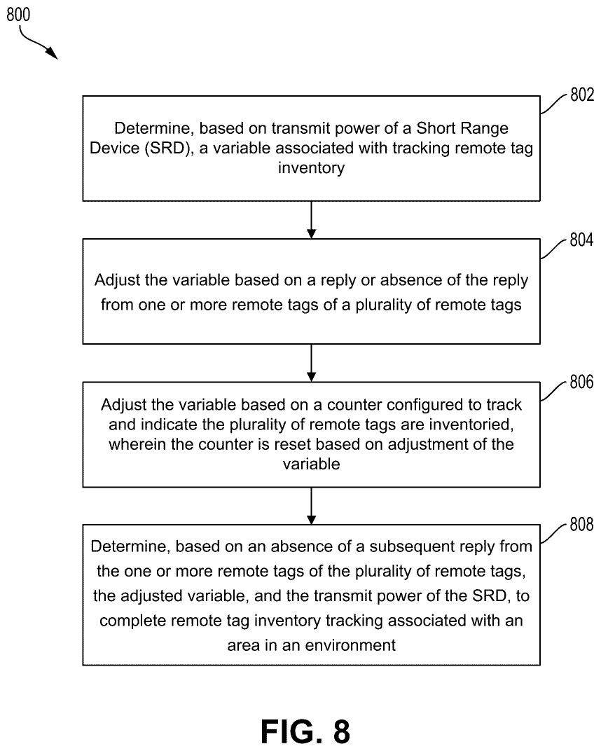

FIG. 8 is a flow diagram illustrating an example process 800 for wireless communication. In particular, the process 800 illustrates an example process of inventorying remote tags, such as the radio frequency (RF) energy harvesting device 140 of FIG. 1, the remote tag 350 of FIG. 3 or the remote tag described in communication with an SRD, such as or including the remote tag reader 402 in the description of FIG. 4. The process 800 can be performed by a computing device (e.g., the device 200 of FIG. 2, the remote tag reader 310 of FIG. 3, the remote tag reader 402 of FIG. 4, the computing device or computing system 900 of FIG. 9, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 800 can be implemented as software components that are executed and run on one or more processors (e.g., processor 210 of FIG. 2, the processor 910 of FIG. 9, or other processor(s)) of the computing device. Further, the transmission and reception of signals by the computing device in the process 800 can be enabled, for example, by one or more antennas and/or one or more transceivers (e.g., wireless transceiver(s)).

At block 802, the computing device (or component thereof) can determine, based on transmit power of a Short Range Device Radio (SRD), a variable associated with tracking remote tag inventory. In some examples, the SRD can be a remote tag reader. In other examples, the SRD can include a remote tag reader. For example, the variable can be a parameter or variable associated with a number of slots to provide to a plurality of remote tags to determine when the remote tags should transmit messages to the SRD (e.g., a Q-value). In some examples, the variable is a floating point variable associated with tracking the remote tag inventory (e.g., Q_{fp}). In further examples, the transmit power can be a max transmit power of the SRD (e.g., the max transmit power for which the SRD is rated). In such an example, the max transmission power can be associated with a maximum range of communication of the SRD.

At block 804, the computing device (or component thereof) can adjust the variable based on a reply or absence of the reply from one or more remote tags of a plurality of remote tags. In some examples, the adjustments to the variable can include incrementing or decrementing the variable. For example, the computing device (or component thereof) can increment the variable based on the reply. In some examples, the SRD can transmit a message to the plurality of remote tags. The remote tags can transmit messages to the SRD in reply to the transmitted messages of the SRD.

In some examples, the computing device (or component thereof) can adjust the variable based on the reply associated with a first remote tag, wherein the adjustments to the variable include a decremental adjustment of the variable based on the absence of the reply, an incremental adjustment of the variable based on a collision of multiple remote tag replies, and maintain as is the variable based on the reply being decoded. For example, remote tags can generate a random number based on the variable to determine when to reply to the SRD. In some examples, two or more remote tags may generate the same random number and reply within a same period resulting in a collision (e.g., the SRD receiving multiple replies within a same period).

In some examples, the decremental adjustment and incremental adjustment can be adaptive. For example, the decremental adjustment and incremental adjustment can be associated with an adaptive ratio based on a determined rate of failed remote tag detection and a determined rate of collision of replies of the plurality of remote tags. In such an example, the computing device (or component thereof) can determine inventorying statistics (e.g., the rate of collisions, rate of no replies, etc.). The decremental and incremental adjustments can be changed (e.g., increased or decreased) based on the inventorying statistics. In some examples, the decremental adjustment can be greater than the incremental adjustment. In further examples, the decremental adjustment can decrease based on a success rate of resolved collisions.

At block 806, the computing device (or component thereof) can adjust the variable based on a counter configured to track and indicate the plurality of remote tags are inventoried. In such an example, the counter can be reset based on adjustment of the variable. In some examples, the computing device (or a component thereof) can determine to adjust an order of the replies of the plurality of remote tags based on a comparison of the adjusted variable to a different data type representation of the adjusted variable. For example, the adjusted variable can be an integer based representation and can be compared to a floating point data type representation of the adjusted variable. When there is a deviation between the floating point representation and the integer variable, the adjusted variable can be rounded to the nearest integer value (e.g., rounded up or down) of the floating point data type representation of the adjusted variable. In an example where the adjusted variable is updated in value, the computing device (or component thereof) can determine to adjust the order of replies of the plurality of remote tags. For example, the updated Q-value associated with the adjusted variable can be provided to the plurality of remote tags (e.g., the remote tags from the plurality which have not been inventoried). The remote tags can generate random numbers based on the Q-value indicating an order for responding to the SRD. In some examples, the computing device (or component thereof) can adjust the order of replies of the plurality of remote tags based on a query adjust command and the adjusted variable.

At block 808, the computing device (or component thereof) can determine, based on an absence of a subsequent reply from the one or more remote tags of the plurality of remote tags, the adjusted variable, and the transmit power of the SRD, to complete remote tag inventory tracking associated with an area in an environment. In some examples, the computing device (or component thereof) can determine, based on the absence of the subsequent reply from the one or more remote tags of the plurality of remote tags, the adjusted variable, and the transmit power of the SRD, to complete the remote tag inventory tracking associated with the area in the environment, wherein the transmit power of the SRD (or remote tag reader) is set at or above a predetermined threshold power. For example, the predetermined threshold power can be the maximum transmit power of the SRD (e.g., a maximum transmit power of which the SRD is rated).

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, an engine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:
Aspect 1. An apparatus for wireless communications, the apparatus comprising: at least one memory; and at least one processor coupled to the at least one memory and configured to: determine, based on transmit power of a Short Range Device (SRD), a variable associated with tracking remote tag inventory; adjust the variable based on a reply or absence of the reply from one or more remote tags of a plurality of remote tags; adjust the variable based on a counter configured to track and indicate the plurality of remote tags are inventoried, wherein the counter is reset based on adjustment of the variable; and determine, based on an absence of a subsequent reply from the one or more remote tags of the plurality of remote tags, the adjusted variable, and the transmit power of the SRD, to complete remote tag inventory tracking associated with an area in an environment.
Aspect 2. The apparatus of Aspect 1, wherein the at least one processor is configured to: determine to adjust an order of the replies of the plurality of remote tags based on a comparison of the adjusted variable to a different data type representation of the adjusted variable.
Aspect 3. The apparatus of any of Aspects 1 to 2, wherein adjustments include decrementing or incrementing the variable based on the reply or the absence of the reply.
Aspect 4. The apparatus of any of Aspects 1 to 3, wherein the at least one processor is configured to: adjust the variable based on the reply or an absence of the reply associated with a first remote tag, wherein the adjustments to the variable include a decremental adjustment of the variable based on the absence of the reply, an incremental adjustment of the variable based on a collision of multiple remote tag replies, and maintain as is the variable based on the reply being decoded.
Aspect 5. The apparatus of any of Aspects 1 to 4, wherein a ratio of decremental adjustment to incremental adjustment are adaptive based on a determined rate of failed remote tag detection and a determined rate of collision of replies of the plurality of remote tags.
Aspect 6. The apparatus of any of Aspects 1 to 5, wherein the decremental adjustment is greater than the incremental adjustment.
Aspect 7. The apparatus of any of Aspects 1 to 6, wherein the decremental adjustment decreases based on a success rate of resolved collisions.
Aspect 8. The apparatus of any of Aspects 1 to 7, wherein the at least one processor is configured to: adjust an order of replies of the plurality of remote tags based on a query adjust command and the adjusted variable.
Aspect 9. The apparatus of any of Aspects 1 to 8, wherein the variable is a floating point variable associated with tracking the remote tag inventory.
Aspect 10. The apparatus of any of Aspects 1 to 9, wherein the at least one processor is configured to: determine, based on the absence of the subsequent reply from the one or more remote tags of the plurality of remote tags, the adjusted variable and the transmit power of the SRD, to complete the remote tag inventory tracking associated with the area in the environment, wherein the transmit power of the SRD is set at or above a predetermined threshold power.
Aspect 11. A method for wireless communications, the method comprising: determining, based on transmit power of a Short Range Device (SRD), a variable associated with tracking remote tag inventory; adjusting the variable based on a reply or absence of the reply from one or more remote tags of a plurality of remote tags; adjusting the variable based on a counter configured to track and indicate the plurality of remote tags are inventoried; wherein the counter is reset based on adjustment of the variable; and determining, based on an absence of a subsequent reply from the one or more remote tags of the plurality of remote tags, the adjusted variable, and the transmit power of the SRD, to complete remote tag inventory tracking associated with an area in an environment.
Aspect 12. The method of Aspect 11, further comprising: determining to adjust an order of the replies of the plurality of remote tags based on a comparison of the adjusted variable to a different data type representation of the adjusted variable.
Aspect 13. The method of any of Aspects 11 to 12, wherein adjustments include decrementing or incrementing the variable based on the reply or the absence of the reply.
Aspect 14. The method of any of Aspects 11 to 13, further comprising: adjusting the variable based on the reply or an absence of the reply associated with a first remote tag, wherein the adjustments to the variable include a decremental adjustment of the variable based on the absence of the reply, an incremental adjustment of the variable based on a collision of multiple remote tag replies, and maintain as is the variable based on the reply being decoded.
Aspect 15. The method of any of Aspects 11 to 14, wherein a ratio of decremental adjustment to incremental adjustment are adaptive based on a determined rate of failed remote tag detection and a determined rate of collision of replies of the plurality of remote tags.
Aspect 16. The method of any of Aspects 11 to 15, wherein the decremental adjustment is greater than the incremental adjustment.
Aspect 17. The method of any of Aspects 11 to 16, wherein the decremental adjustment decreases based on a success rate of resolved collisions.
Aspect 18. The method of any of Aspects 11 to 17, further comprising: adjusting an order of replies of the plurality of remote tags based on a query adjust command and the adjusted variable.
Aspect 19. The method of any of Aspects 11 to 18, wherein the variable is a floating point variable associated with tracking the remote tag inventory.
Aspect 20. The method of any of Aspects 11 to 19, further comprising: determining, based on the absence of the subsequent reply from the one or more remote tags of the plurality of remote tags, the adjusted variable, and the transmit power of the SRD, to complete the remote tag inventory tracking associated with the area in the environment, wherein the transmit power of the SRD is set at or above a predetermined threshold power.
Aspect 21. A non-transitory computer-readable medium having stored thereon instructions that, when executed by at least one processor, cause the at least one processor to perform one or more of operations according to any of Aspects 11 to 20.
Aspect 22. An apparatus for sensor calibration, the apparatus comprising one or more means for performing operations according to any of Aspects 11 to 20.

1. An apparatus for wireless communications, the apparatus comprising:
at least one memory; and
at least one processor coupled to the at least one memory and configured to:
initialize, based on a determined transmit power level at which a Short Range Device (SRD) is configured to transmit an interrogation signal to a plurality of remote tags, a variable associated with tracking remote tag inventory, wherein an initial value of the variable is based on the determined transmit power level;
adjust the variable based on a reply or absence of the reply from one or more remote tags of the plurality of remote tags;
adjust the variable based on a counter configured to track and indicate the plurality of remote tags are inventoried, wherein the counter is reset based on adjustment of the variable; and
determine, based on an absence of a subsequent reply from the one or more remote tags of the plurality of remote tags, the adjusted variable, and the determined transmit power level of the SRD, to complete remote tag inventory tracking associated with an area in an environment.

2. The apparatus of claim 1, wherein the at least one processor is configured to:
determine to adjust an order of replies of the plurality of remote tags based on a comparison of the adjusted variable to a different data type representation of the adjusted variable.

3. The apparatus of claim 1, wherein adjustments include decrementing or incrementing the variable based on the reply or the absence of the reply.

4. The apparatus of claim 1, wherein the at least one processor is configured to:
adjust the variable based on the reply or the absence of the reply associated with a first remote tag, wherein the adjustments to the variable include a decremental adjustment of the variable based on the absence of the reply, an incremental adjustment of the variable based on a collision of multiple remote tag replies, and maintain as is the variable based on the reply being decoded.

5. The apparatus of claim 4, wherein a ratio of decremental adjustment to incremental adjustment is adaptive based on a determined rate of failed remote tag detection and a determined rate of collision of replies of the plurality of remote tags.

6. The apparatus of claim 5, wherein the decremental adjustment is greater than the incremental adjustment.

7. The apparatus of claim 5, wherein the decremental adjustment decreases based on a success rate of resolved collisions.

8. The apparatus of claim 1, wherein the at least one processor is configured to:
adjust an order of replies of the plurality of remote tags based on a query adjust command and the adjusted variable.

9. The apparatus of claim 1, wherein the variable is a floating point variable associated with tracking the remote tag inventory.

10. The apparatus of claim 1, wherein the at least one processor is configured to:
determine, based on the absence of the subsequent reply from the one or more remote tags of the plurality of remote tags, the adjusted variable, and the determined transmit power level of the SRD, to complete the remote tag inventory tracking associated with the area in the environment, wherein the determined transmit power level of the SRD is set at or above a predetermined threshold power.

11. A method for wireless communications, the method comprising:
initializing, based on a determined transmit power level at which a Short Range Device (SRD) is configured to transmit an interrogation signal to a plurality of remote tags, a variable associated with tracking remote tag inventory, wherein an initial value of the variable is based on the determined transmit power level;
adjusting the variable based on a reply or absence of the reply from one or more remote tags of the plurality of remote tags;
adjusting the variable based on a counter configured to track and indicate the plurality of remote tags are inventoried; wherein the counter is reset based on adjustment of the variable; and
determining, based on an absence of a subsequent reply from the one or more remote tags of the plurality of remote tags, the adjusted variable, and the determined transmit power level of the SRD, to complete remote tag inventory tracking associated with an area in an environment.

12. The method of claim 11, further comprising:
determining to adjust an order of replies of the plurality of remote tags based on a comparison of the adjusted variable to a different data type representation of the adjusted variable.

13. The method of claim 11, wherein adjustments include decrementing or incrementing the variable based on the reply or the absence of the reply.

14. The method of claim 11, further comprising:
adjusting the variable based on the reply or absence of the reply associated with a first remote tag, wherein the adjustments to the variable include a decremental adjustment of the variable based on the absence of the reply, an incremental adjustment of the variable based on a collision of multiple remote tag replies, and maintain as is the variable based on the reply being decoded.

15. The method of claim 14, wherein a ratio of decremental adjustment to incremental adjustment are adaptive based on a determined rate of failed remote tag detection and a determined rate of collision of replies of the plurality of remote tags.

16. The method of claim 15, wherein the decremental adjustment is greater than the incremental adjustment.

17. The method of claim 15, wherein the decremental adjustment decreases based on a success rate of resolved collisions.

18. The method of claim 11, further comprising:
adjusting an order of replies of the plurality of remote tags based on a query adjust command and the adjusted variable.

19. (canceled)

20. A non-transitory computer-readable medium having stored thereon instructions that, when executed by at least one processor, cause the at least one processor to:
initialize, based on a determined transmit power level at which a Short Range Device (SRD) is configured to transmit an interrogation signal to a plurality of remote tags, a variable associated with tracking remote tag inventory, wherein an initial value of the variable is based on the determined transmit power level;
adjust the variable based on a reply or absence of the reply from one or more remote tags of the plurality of remote tags;
adjust the variable based on a counter configured to track and indicate the plurality of remote tags are inventoried; wherein the counter is reset based on adjustment of the variable; and
determine, based on an absence of a subsequent reply from the one or more remote tags of the plurality of remote tags, the adjusted variable, and the determined transmit power level of the SRD, to complete remote tag inventory tracking associated with an area in an environment.

21. The apparatus of claim 1, wherein, to initialize the variable, the at least one processor is configured to determine a number of remote tags within a communication range corresponding to the determined transmit power level and setting the initial value of the variable based on the number of remote tags.
